(19) United States
(12) Patent Application Publication
(10) Pub. No.: US 2006/0024206 A1
(43) Pub. Date: Feb. 2, 2006

(54) Non-invasive acoustic technique for mixing and segregation of fluid suspensions in microfluidic applications

(76) Inventors: Naveen Neil Sinha, Los Alamos, NM (US); Gregory Kaduchak, Los Alamos, NM (US); Dipen N. Sinha, Los Alamos, NM (US); Peter A. Adcock, Campbellsville, KY (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/958,886

(22) Filed: Oct. 5, 2004

Related U.S. Application Data
(60) Provisional application No. 60/592,082, filed on Jul. 29, 2004.

(51) Int. Cl. B01L 3/00

(52) U.S. Cl. 422/100; 436/180

(57) ABSTRACT

The present invention includes an apparatus and corresponding method for fluid flow control in microfluidic applications. A microchamber, filled with a fluid, is in fluid contact with a flexible plate. A transducer is acoustically coupled to the flexible plate. A function generator outputs a signal to excite the transducer, which in turn induces drumhead vibration of the flexible plate, creating a flow pattern within the fluid filled microchamber.

### RELATED APPLICATIONS

This application claims the benefit of provisional application no. 60/592,082 filed on Jul. 29, 2004, titled “Non-invasive Acoustic Technique for Mixing and Segregation of Fluid Suspensions in Microfluidic Applications”.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally controlling fluid flow and fluid suspensions, and, more particularly, to use of low frequency vibrations to control fluidic functions, such as pumping, stirring, filtering and manipulation of fluids and suspensions in microfluidic applications.

### BACKGROUND OF THE INVENTION

The field of microfluidics includes the manipulation and control of fluids on small-scales (one dimension less than 1 mm). These fluids may be pure fluids or suspensions containing particulate matter (e.g. biological cells). There are a wide range of microfluidic applications within the chemical and biotechnology industries, including combinatorial chemistry, biological assays, and biochemical synthesis.

Current efforts include making more complex and versatile systems like a “Lab on a Chip,” which would replace a room full of bench-top equipment with a small-scale system of microchannels and reaction chambers. To facilitate chemical or biological reactions in such systems, the ability to control and mix various reagents and chemicals in the micro-scale is necessary. This includes propelling fluids from one part of the device to another, controlling fluid motion, providing enhanced mixing, and separating fluids and suspended particles. Thus, mesoscopic equivalents of traditional fluid control components need to be developed, such as pumps, valves, mixers, and filters. Since fluids behave differently when confined to small length scales compared to macroscopic systems, new technologies are required for microfluidic applications.

There are no general-purpose techniques for the performance of multiple functional manipulations within fluid systems on the microfluidic scale. Current methods include small magnetic stir bars, micro-pumps, electro-hydrodynamics devices, high frequency flexural wave devices, and ultrasonic actuation. However, all of these techniques are limited in scope, i.e., perform only a single function, such as either to mix or to pump fluids To date there are three main approaches involving the use of vibration to manipulate fluids in a small-scale confined geometry:

The first, a high-frequency approach, uses acoustic streaming to pump the fluids away from a piezoelectric element. U.S. Pat. No. 6,326,211, “Method of Manipulating A Gas Bubble in a Microfluidic Device”, by Anderson et al., teaches this first technique. An example taught by Anderson et al. involves the use a PZT element in contact with a rigid wall, adjacent to the mixing (reaction) chamber, which generates sonic vibrations that traverse the solid wall and into the sample, providing the motive force to mix the sample. However, this technique uses high power, leading to cavitation that may damage the contents (e.g. biological cells) of the subject microfluidic chamber.

The second, a low frequency approach, uses an oscillating rod to create stable vortices and to trap suspended particles. However, this technique is invasive, which is a major drawback. (Reference: Barry R. Lutz, Jian Chen, and Daniel T. Schwartz, Microfluidics without Microfabrication, PNAS, April 2003; 100: 4395-4398)

The third, a bubble-based approach, uses a series of microscopic resonating bubbles that create flow patterns around the oscillating pocket of gas. This technique has the disadvantage of requiring a collection of identically sized bubbles and accurately machined bubble traps, which can be difficult to produce in practice. Another bubble-based approach, the use of thermally generated bubbles has also been used as a form of micro-pump. (Reference: Liu, R H; Yang, J N; Pindera, M Z; Athavale, M; Grodzinski, P; Bubble-induced Acoustic Micromixing LAB ON A CHIP; 2002; v.2, no. 3, p.151-157).

Various objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes an apparatus and corresponding method for fluid flow control in microfluidic applications. A microchamber, filled with a fluid, is in fluid contact with a flexible plate. A transducer is acoustically coupled to the flexible plate. A function generator outputs a signal to excite the transducer, which in turn induces drumhead vibration of the flexible plate, creating a flow pattern within the fluid filled microchamber.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIGS. 1a and 1b are cross-sectional illustrations of the present invention.

FIG. 2 is a pictorial illustration demonstrating the flow pattern generation mechanism of the present invention.

FIG. 3 is a pictorial illustration of drum head resonance leading to dipole and quadrupole flow patterns within a microfluidic chamber.

FIGS. 4a, 4b, and 4c are pictures of actual flow patterns created within a microfluidic chamber by the present invention.

FIG. 5 is a picture detailing the use of tape within a microfluidic chamber to direct fluid and particle flow created by the present invention.

FIG. 6 is a pictorial illustration displaying a functional use of the present invention.

FIGS. 7a and 7b are a pictorial illustration of a separation technique provided by the present invention.

### DETAILED DESCRIPTION

The present invention is an apparatus and method for controlling fluid flow, mixing fluids, or segregating fluids within one or more microfluidic chambers. The differing operations can all be accomplished with the same apparatus, allowing for versatility of application.

The apparatus comprises a flexible plate in fluid contact with a thin fluid chamber. Through induction of a low frequency (<1 MHz), by an appropriate transduction method, vibration of the flexible plate induces a flow pattern within the fluid chamber. Changing the frequency, amplitude, and waveform of the electrical signal that drives the plate vibration controls the fluid flow patterns within the chamber, allowing the contents of the chamber to be mixed or separated according to physical properties. For example, applications for separation may include separating white blood cells from red blood cells, or simply separating blood cells from the plasma. Applications for mixing may include the field of electrochemistry, where an electrochemical reaction on micro- or nano-particles is performed within the confines of a microchannel.

Simply adjusting the drive signal characteristics of the transducer can control the fluid flow speed. For example, the fluid flow can be completely stopped and restarted without using a valve simply by applying an amplitude modulated excitation signal. The flow speed can be varied either by the amplitude of the excitation signal or varying the waveform, such as square wave instead of sine wave. This technique is particularly well suited for working with larger amounts of fluids (>nanoliters) than the traditional amount (<nanoliters, and as small as picoliters) used in microfluidics.

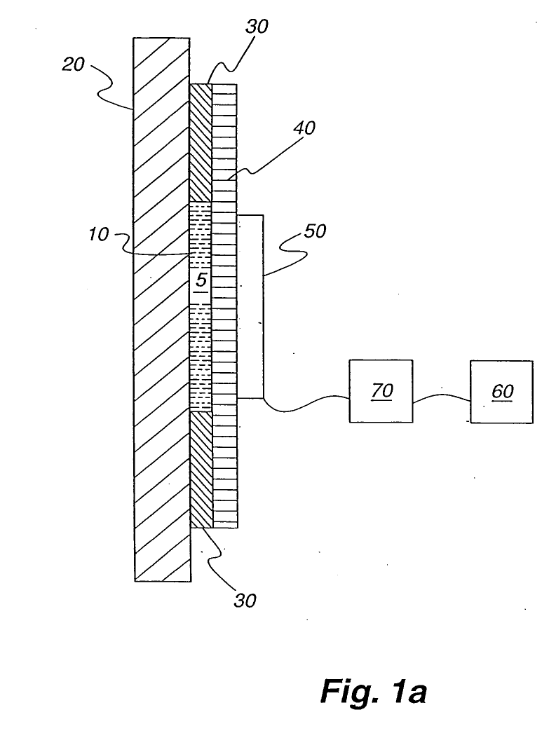

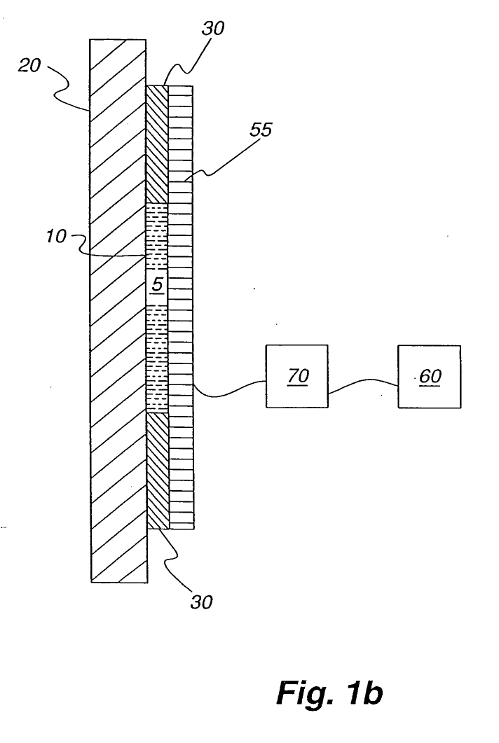

The present invention may be used in a wide variety of applications and corresponding configurations. The setup in FIGS. 1a and 1b were chosen for ease of visualizing the effects of the present invention on the contents of a microfluidic chamber. Referring now to FIG. 1a, the embodiment shown comprises fluid 5 within microchamber 10 created by Plexiglas® block 20, spacer 30, and flexible plate 40. A microchamber is defined as any enclosure with at least one dimension (length, width, or height) less than or equal to 1 millimeter. Any solid flexible material (metals, graphite, polymers, semiconductors, insulators, composite material, etc.) may be used for flexible plate 40 in order to adapt the present invention to a wide range of applications. The function of flexible plate 40 is to allow periodic spatial deformation of the plate surface to produce a desired pattern of surface deflections, or, in other words, capable of forming a drumhead response under applied acoustic frequencies. Other rigid materials (e.g. microscopic slide, metal plate, polycarbonate, semiconductor plates) may also be used instead of the Plexiglass® block 20. Plexiglass® was used to facilitate flow visualization because it is optically transparent. If visualization is not required, then any material that is stiff enough to resist deformation may be used.

Transducer 50 is acoustically coupled with ultra sonic coupling gel, or other similar substance, to plate 40 and transmits a signal from function generator 60. Any suitable voltage source circuit known to those skilled in the art that generates a variety of voltage waveforms of varying frequencies (e.g. sine-wave, square wave, triangle wave, frequency modulated signal, amplitude modulated signal, frequency sweep signal, etc.) may be used for function generator 60. Any transducer known to those skilled in the art that converts an input signal into an acoustic vibration may be used as transducer 50. Referring to FIG. 1b, in another embodiment, a flexible transducer 55 may be used in lieu of flexible plate 40, thus, incorporating the function of flexible plate 40.

In one embodiment, transducer 50 is a piezoelectric transducer (also called a “disc bender”) that comprises a thin piezoelectric disc glued to a larger brass disc 50 mm in diameter. Transducer 50 vibrates like the surface of a drumhead at low frequency (<50 Hz), producing relatively large displacements compared to ordinary piezoelectric discs that vibrate at higher frequencies (>1000 Hz).

Transducer 50 may be selected from any transducer known to those practiced in the art, to include: piezoceramic, piezosalt, piezopolymer, piezocrystal, magnetostrictive, or electromagnetic transducers. Note that since transducer 50 is simply used to vibrate flexible plate 40 other electromagnetic or mechanical methods known to those skilled in the art may also be used for this application. In fact, any means that allows a periodic spatial deformation of flexible plate 40 will suffice. In particular, one embodiment of transducer 50 includes a 2-dimensional array of smaller piezoelectric elements that can be controlled individually to produce a number of spatial surface deflection patterns on flexible plate 40. This embodiment would be particularly suitable for very thin fluid chambers, providing enhanced flexibility in creating very complex spatial patterns by controlling individual piezoelectric elements separately.

Microchamber 10 is not limited to any particular shape or size. Various fluids (e.g., pure fluids, emulsions, suspensions, mixtures, etc.) may be used as fluid 5. The speed of the fluid flow within microchamber 10 depends on the viscosity of fluid 5 and the local volume change resulting from the “squeezing” action of flexible plate 40.

Separation of differing materials occurs due to centripetal forces on individual particles suspended within the fluid. The different material particles will experience different amounts of force based on inherent physical characteristics, and will separate from each other over time. The degree of separation will depend on amplitude of vibration, fluid layer thickness, and viscosity of the fluid.

Mixing of fluid and suspended particles occurs when the vibration mode is changed such that the fluid is forced from one flow pattern to another. The flow speed may be controlled through signal amplitude modulation, to include starting and stopping flow in a periodic manner.

Particular flow patterns (e.g. mixing and segregation) occur over a relatively wide range of frequencies, rather than at exact drum-head modes frequencies, due primarily to asymmetries in the shape of the given microchamber used. Thus, the microchamber asymmetry tends to broaden the width of the drumhead resonance modes.

Using the apparatus described in FIGS. 1a and 1b, fluid flow, mixing, and separation behavior were observed in microchamber 10. Microchamber 10 dimensions were approximately 3 cm in diameter with a depth ranging from 200 microns to 1 mm. Spacer 30, about 200 to 1000 μm thick, was made from Teflon®. Plate 40 was a 127 μm (0.005″) thick brass plate. Carbon black particles were added to the water inside microchamber 10 in order to facilitate visualization and monitoring of fluid motion.

Transducer 50, a piezoelectric transducer (also called a “disc bender”), comprised a thin piezoelectric disc glued to a larger brass disc. Transducer 50, 50 mm in diameter, vibrated like the surface of a drumhead, producing relatively large displacements compared to ordinary piezoelectric discs. Transducer 50 was coupled to metal plate 40 using ultrasonic coupling gel and was excited by function generator 60 (Stanford Research System DS345). Power amplifier 70 (Krohn-Hite Model DCA-10) amplified the output of function generator 60, but is not required to practice the present invention. Note that with proper impedance matching, e.g., use of a transformer, the power requirements for observing the acoustic flow patterns described can be reduced below 1 Watt. Note, by using a commercial laser Doppler vibrometer that senses vibrations of a surface with sub-micron resolution, it was determined that the surface vibration pattern of flexible plate 40 was primarily the result of drumhead mode excitation.

When function generator 60 applied a low frequency (<1 kHz) sonic vibration to plate 40, convection-like patterns were created in the fluid within chamber 10.

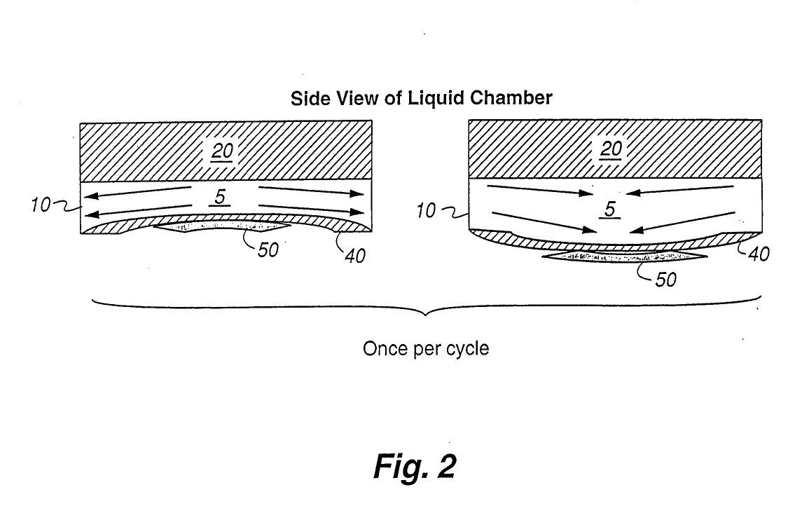

The flow patterns that arise within the chamber result from a combination of the periodically changing dimensions of the fluid height within chamber 10. Referring now to FIG. 2, as flexible plate 40 vibrates, the width of fluid chamber 10 alternately compresses and expands, exhibiting a particular pattern that is a function of the signal from transducer 50. As plate 40 compresses fluid 5, fluid 5 is forced away from the locations of compression to locations not in compression.

Flexible plate 40 movements at the lowest frequencies (<50 Hz) produced chamber 10 volume changes that were less than 0.1% of the total volume as determined by observing a fluid meniscus in a tube (not shown) attached to chamber 10. At higher frequencies, the volume change was not observable. The flow patterns observed within chamber 10 were not induced by acoustic streaming or an acoustic field within chamber 10, as is the case for plate wave fluid transport, but rather a process equivalent to mechanical pumping of a fluid in a confined space induced by flexible plate 40, where the distribution of fluid is manifest by the bending pattern created by the mode of excitation provided by transducer 50.

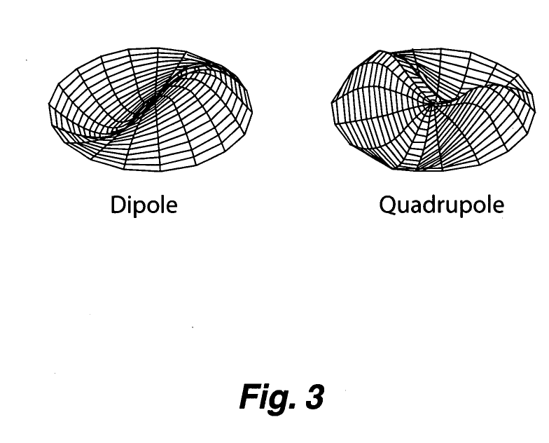

To create specific flow patterns that are stable over time, it is necessary to establish particular vibration patterns with plate 40. In particular, the dipole and quadruple flow patterns exhibited in FIG. 2 were created from the associated drum head resonance of plate 40. Note that drumhead resonance modes may not be perfect, as shown in FIG. 3, due to the varying geometries that may be employed in differing embodiments of chamber 10. The resulting asymmetry in the configuration tends to broaden the resonance frequencies due to the degenerate resonance modes (multiple resonance modes having same resonance frequency) that tend to separate out the resonance frequencies that normally overlap in a symmetric system. This allows for a range of flow patterns observed over a large frequency range that are slightly different in characteristics but reproducible.

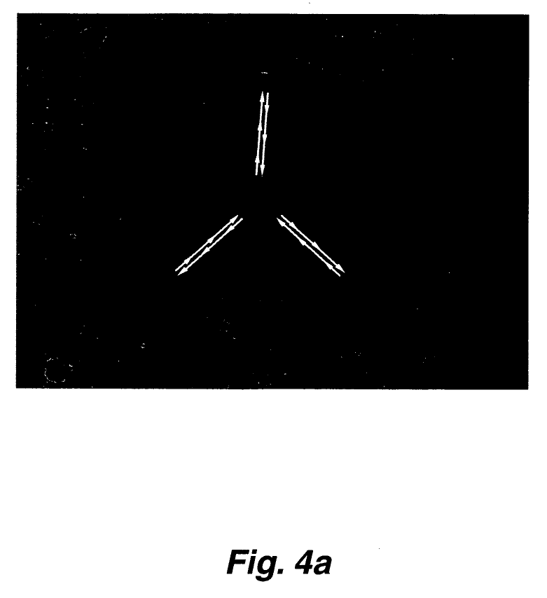

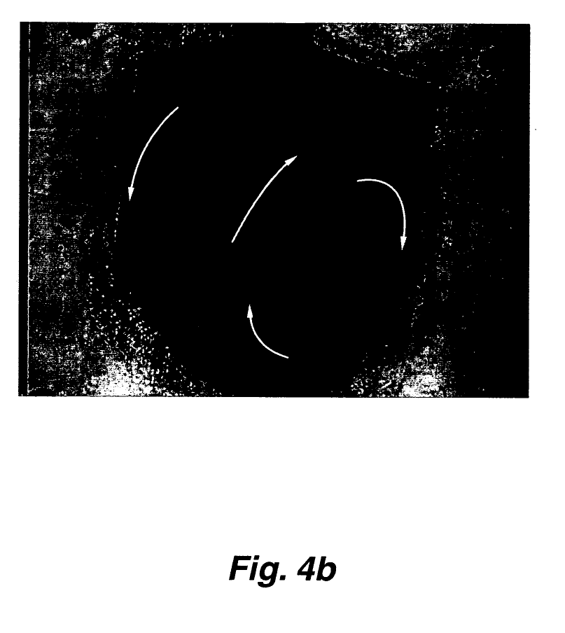

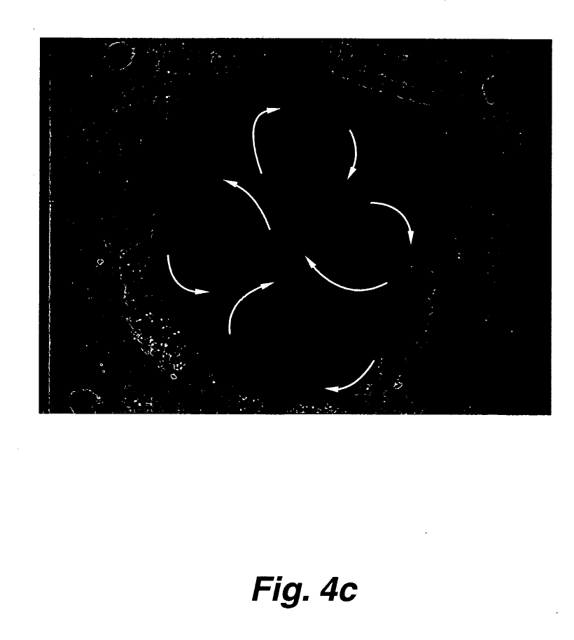

FIGS. 4a, 4b and 4c display the various flow patterns generated within a homogeneous mixture of carbon black and titanium dioxide particles in water located in microchamber 10 by varying the frequency applied to transducer 50. Three distinct flow patterns were created at different frequencies. Referring to FIG. 4a, at frequencies less than 30 Hz, the carbon black particles moved symmetrically towards and away from the center of the chamber. At frequencies of 70 to 200 Hz, FIG. 4b shows convection-like, dipole patterns were established.

Referring to FIG. 4c, at frequencies of 200 Hz to 1 kHz, more complicated mixing patterns were observed, and stable patterns, such as quadrupoles were established. Note, at frequencies greater than 1 kHz, very little flow or mixing was observed because the corresponding flexible plate 40 vibration amplitude was too low to create significant hydrodynamic flow within the chamber 10.

At higher frequencies, higher mode vibrations are created. This means that the spatial pattern on the plate surface is more finely dimpled (closely spaced amplitude variation). At these higher frequencies, the suspended particles respond slowly to fast changes in fluid motion due to viscous drag effects. This effect depends on the size of the suspended particles and the viscosity of the fluid. Note, for smaller particles in a lower viscosity fluid, one may observe this effect to take place at frequencies higher than 1 kHz. This limiting frequency scales with the physical parameters mentioned previously.

In general, the flow patterns observed were stable over a frequency range that exceeded 30% (˜100 Hz) of the resonance frequency of any induced drumhead mode (dipole, quadrupole etc.). A few specific frequencies corresponding to the dipole and quadrupole modes created flow patterns that were symmetric (e.g., equal size flow loops), but as the frequency deviated on either side of these frequencies, the flow patterns became more asymmetric (e.g. one flow loop larger than the other or particles collecting around the edges of one flow loop and in the center of another). Thus, it was demonstrated that by simply adjusting the frequency finer control over the exhibited flow pattern is possible.

The speed exhibited by fluid 5, while moving in the various patterns, depends on several factors: the dimensions of chamber 10, the amplitude of transducer 50 vibrations, the thickness of plate 40, and the waveform used to excite transducer 50. The fluid flow speed is approximately proportional to the amplitude of the signal used to excite the transducer. This is a linear approximation from Bernoulli's law, which states that the velocity of the flow would be inversely proportional to the fractional change in dimension of microchamber 10 due to plate 40. The amplitude of vibration of the flexible plate 40 is directly related to the amplitude of the excitation signal from transducer 50. The highest fluid 5 flow speed observed was approximately 3 cm/s; this value was determined by frame-by-frame analysis of video pictures taken with a digital video camera.

Through amplitude modulation of the excitation signal, fluid flow can be made to alternate between flowing and stationary states, similar to flow control with a valve. This type of simple flow control can be very useful in designing various microfluidic applications, including biological cell manipulations. The velocity of the fluid within the flow patterns decreased as the thickness of plate 40 was increased. Observable flow patterns exist from 127 μm (0.005″) to 381 μm (0.015″). Fluid flow velocity decreased as the width of chamber 10 was increased because the amplitude of vibration depends on the power applied and the plate thickness. As a result of the confined space within the microchannel, a combination of the finite displacement of the plate (drum-head mode vibration) with respect to the total thickness of the confined fluid determines the effectiveness of inducing fluid flow. If the ratio of the vibration amplitude to the fluid depth (microchannel depth) is too small, the induced flow velocity will become small as well and will disappear below a minimum threshold value that depends on the particular geometry of microchamber 10.

There are several methods that may be employed to modify the shape of flow patterns. One method is to change the position of the transducer relative to the center of microchamber 10. Another method is to alter the inner surface of microchamber 10, for example by placing strips of tape or creating grooves on the surfaces within microchamber 10.

Fluid flow patterns were not affected by tightening screws around fluid chamber 10, applying pressure to the back of transducer 50, or changing the orientation of transducer 50 with respect to chamber 10. Note that fluid flow patterns are not dependent on whether chamber 10 is oriented vertically or horizontally, as the strength of the mechanical pushing exhibited by the drum-head vibration of plate 40 on fluid 5 is orders of magnitude higher than the force of gravity on fluid 5.

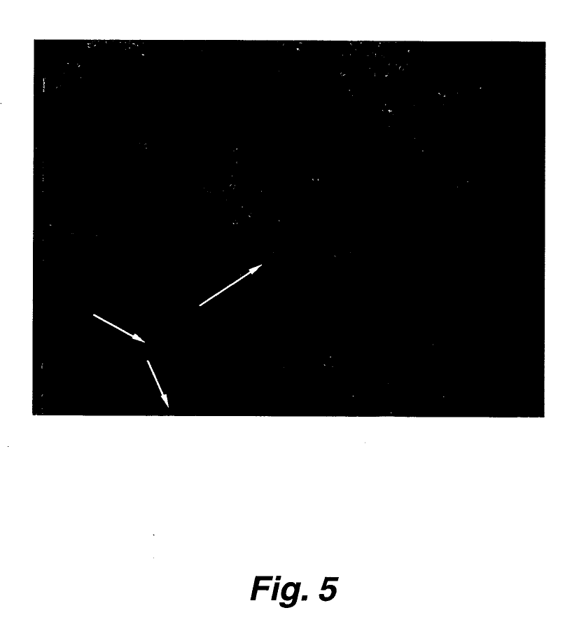

In other embodiments, modification of the surface of plate 40 resulted in alteration of exhibited fluid flow patterns. For example, placing tape with a 50 μm thickness on to the fluid side of plate 40 in various shapes and different numbers of layers resulted in fluid flow velocities that were considerably higher over the area where the pieces of tape overlapped (where the liquid layer was the thinnest); this is consistent with Bernoulli's principle. Thus, with use of this type of application, one can modify flow characteristics to meet any number of operational needs, e.g., sampling. It was determined that a grid of overlapping tape strips, as shown in FIG. 5, induced. particles entrained in fluid 5 to collect at the points where the strips of tape overlapped, providing for functional manipulation of fluid 5 within microchamber 10.

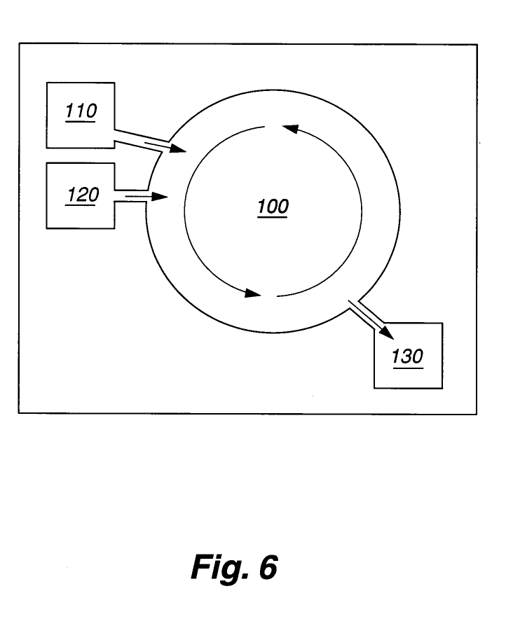

Functional use of the stable flow patterns provided by the present invention makes possible the ability to perform microfluidic mixing operations. For example, referring to FIG. 6, microfluidic mixing chamber 100 is fluidly connected to chambers 110, 120, and 130. Using the present invention, a stable loop flow pattern within chamber 100 may be used to siphon different chemical fluids from chambers 110, 120 and mix them together within chamber 100. Once the desired chemical reaction has taken place, another flow pattern may be induced to direct the mixture into chamber 130 for storage or further processing.

Another function provided by the present invention is the ability to segregate suspended particles. Referring back to FIG. 4b, activation of transducer 50 created a stable loop flow pattern. After a brief period, the carbon black and titanium dioxide particles separated, with the carbon black particles in the centers of the induced flow loops and the titanium dioxide particles flowing around them on the outside. This phenomenon is explained by recognizing that the suspended particles within the circular flow loops experience centrifugal force. Thus, if the densities and the size of the particles are different, this force tends to separate the particles spatially so that these can be extracted from the chamber.

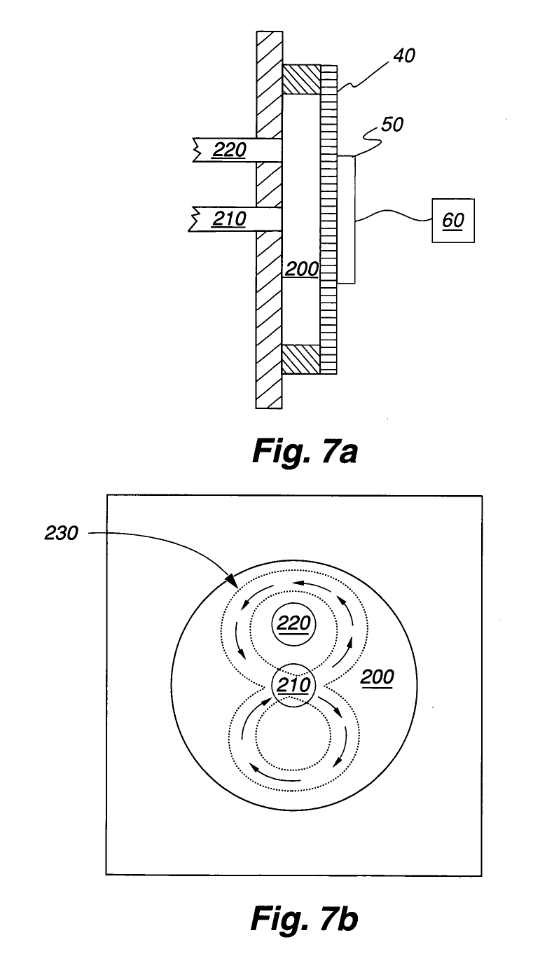

For example, referring to FIGS. 7a and 7b, a solution comprising two distinct particles, e.g. red and white blood cells, enters microfluidic chamber 200 through inlet tube 210. Over time, the circular dipole motion created by the present invention within chamber 200 and the differing physical characteristics of the differing particles, leads to particle separation, where one set of particles circulates within dipole pattern 230 and the other set collects within dipole pattern 230 where outlet tube 220 is located and are then drawn out to another location for processing or analysis.

The present invention is a simple, inexpensive apparatus and corresponding method that may be used to concentrate or mix the contents of thin fluid layers. For example, the transducers used for the example were manufactured by APC International, Limited, and are considered inexpensive at less than ten dollars.

The present invention is simple to implement and does not require photolithography. Traditional microfluidic operations are performed using a photolithography process to make microchannels on a silicon wafer or other material. This process is very similar to making semiconductor integrated circuits and is complicated. Thus, the present invention obviates the need for such sophisticated and expensive processing and opens up possibilities for widespread use by rendering the whole process significantly simpler than currently practiced. The present invention is completely non-invasive as transducer 50 is located outside fluid chamber 10. Finally, the present invention allows for precise control of fluid flow inside microchamber 10 by adjusting the frequency, amplitude, and waveform of the signal inducing the drumhead vibration of flexible plate 40.

The present invention has several applications in the field of microfluidics: first, by controlling the flow rate, the rates of chemical and/or biological reactions can be controlled; second, stationary fluid flow patterns can be set up, acting as micro-chemical traps in a larger application; third, chaotic mixing of two fluids may be performed to provide thorough mixing; and, fourth, fluid flow can be directed along micro-channels existing within a given chamber.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for fluid flow control in microfluidic applications, comprising:
(a) one or more microchambers filled with a fluid;
(b) a flexible plate in fluid contact with said one or more microchambers;
(c) one or more transducers acoustically coupled to said flexible plate; and
(d) a function generator, outputting a signal used to excite said transducer, where said transducer induces drumhead vibration of said flexible plate, creating a flow pattern within said fluid.

2. The apparatus of claim 1, further including a power amplifier to increase an output of said signal.

3. The apparatus of claim 1, where said flexible plate comprises material selected from the group consisting of: metals, graphites, and polymers.

4. The apparatus of claim 1, where said one or more transducers is selected from the group consisting of: piezoceramic, piezosalt, piezopolymer, piezocrystal, magnetostrictive, or electromagnetic transducers.

5. The apparatus of claim 1, where said function generator is selected from any voltage source circuit capable of producing a variety of voltage waveforms of varying frequencies.

6. An apparatus for fluid flow control in microfluidic applications, comprising:
(a) one or more microchambers filled with a fluid;
(b) one or more flexible transducers in fluid contact with said one or more microchambers; and
(c) a function generator, outputting a signal used to excite said transducer, inducing drumhead vibration of said one or more flexible transducers that creates a flow pattern within said fluid.

7. The apparatus of claim 6 further including a power amplifier to increase an output of said signal.

8. The apparatus of claim 6 where said one or more transducers is selected from the group consisting of: piezoceramic, piezosalt, piezopolymer, piezocrystal, magnetostrictive, or electromagnetic transducers.

9. The apparatus of claim 6 where said function generator is selected from any voltage source circuit capable of producing a variety of voltage waveforms of varying frequencies.

10. A method for fluid flow control in microfluidic applications, comprising:
(a) outputting a signal from a function generator to a transducer acoustically coupled to a flexible plate, and
(b) inducing drumhead vibration of said flexible plate in fluid contact with one or more microchambers with said signal, creating one or more flow patterns within said fluid.

11. The method of claim 10, further including adding a waveform of high harmonics to said signal to increase the flow speed of said fluid.

12. The method of claim 10, further including modulating an amplitude of said signal to control the flow speed of said fluid.

13. The method of claim 10, further including sweeping through a frequency range of said signal to mix said fluid.

14. The method of claim 10, further including separating particles of differing physical properties suspended in said fluid with said one or more flow patterns.

15. The method of claim 10, further including altering an inner surface of said microchamber to create said one or more flow patterns.

16. The method of claim 10, further including altering said one or more microchamber dimensions to vary a flow speed of said fluid.

17. The method of claim 10, further including varying the frequency of said signal to create said one or more flow patterns.

18. A method for fluid flow control in microfluidic applications, comprising:
(a) outputting a signal from a function generator to one or more flexible transducers in fluid contact with one or more microchambers, and
(b) inducing drumhead vibration of said one or more flexible transducers in fluid contact with one or more microchambers with said signal, creating one or more flow patterns within said fluid.

19. The method of claim 18, further including adding a waveform of high harmonics to said signal to increase the flow speed of said fluid.

20. The method of claim 18, further including modulating an amplitude of said signal to control the flow speed of said fluid.

21. The method of claim 18, further including sweeping through a frequency range of said signal to mix said fluid.

22. The method of claim 18, further including separating fluid particles of differing physical properties suspended in said fluid with said one or more flow patterns.

23. The method of claim 18, further including altering an inner surface of said microchamber to create said one or more flow patterns.

24. The method of claim 18, further including altering said one or more microchamber dimensions to vary a flow speed of said fluid.

25. The method of claim 18, further including varying the frequency of said signal to create said one or more flow patterns.
